(19) United States
(12) Patent Application Publication
(10) Pub. No.: US 2009/0326704 A1
(43) Pub. Date: Dec. 31, 2009

(54) PROCESSING LOTS THROUGH A CLUSTER TOOL HAVING MULTIPLE PROCESSING CHAMBERS

(75) Inventors: John K. Chan, Hyde Park, NY (US); Jeffrey P. Gifford, Fishkill, NY (US); Eric Krall, Arlington, VA (US)

Correspondence Address: CANTOR COLBURN LLP - IBM FISHKILL, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/145,562

(22) Filed: Jun. 25, 2008

(51) Int. Cl. G06F 19/00

(52) U.S. Cl. 700/121

(57) ABSTRACT

Processing a lot through a cluster tool having multiple processing chambers includes dispatching a lot to a cluster tool having a plurality of processing chambers, determining which of the plurality of processing chambers are active processing chambers and inactive processing chambers, setting a recipe for processing the lot utilizing the active processing chambers of the cluster tool, and processing a portion of the lot through the active processing chambers. Processing the lot further requires detecting that at least one of the inactive processing chambers is a re-activated processing chamber, selectively setting a new recipe for processing a remaining portion of the lot utilizing the active processing chambers and the re-activated processing chamber, and processing the remaining portion of the lot through the cluster tool based on the new recipe.

### BACKGROUND

Many manufacturing systems require multiple types of equipment, including batch and single unit processors. Many single unit processors are cluster tools, i.e., tools having multiple processing chambers. In operation, individual units are directed to appropriate ones of the processing chambers and processed. Often times, one or more of the multiple chambers are of the same process type, allowing multiple units to process simultaneously, i.e., in parallel, thus increasing throughput for individual processes.

In an automated manufacturing environment, one process design consideration is maintaining optimal utilization and throughput on cluster tools. Communications pass between the cluster tools and an automated real time dispatching (RTD) system through a manufacturing execution system (MES). When one or more of the multiple processing chambers on a particular processing tool are unavailable, e.g., there may be a scheduled or unscheduled downtime, the RTD analyzes process resource capabilities and determines, real time, which of several process recipes to dispatch to the cluster tool for processing in available processing chambers. Once the recipe is set, changes cannot be made until a lot has completed processing. Thus, if a processing chamber becomes available while a lot is processing, the additional resource remains unused until the lot finishes processing and a new lot can be dispatched to the cluster tool. As a result, cluster tools may be under utilized for prolonged periods. Under utilization increases production time and processing costs.

### SUMMARY

Exemplary embodiments of the invention include processing a lot through a cluster tool having multiple processing chambers includes dispatching a lot to a cluster tool having a plurality of processing chambers, determining which of the plurality of processing chambers are active processing chambers and inactive processing chambers, setting a recipe for processing the lot utilizing the active processing chambers of the cluster tool, and processing a portion of the lot through the active processing chambers. The exemplary embodiments also include detecting that at least one of the inactive processing chambers is a re-activated processing chamber, selectively setting a new recipe for processing a remaining portion of the lot utilizing the active processing chambers and the re-activated processing chamber, and processing the remaining portion of the lot through the cluster tool based on the new recipe.

System and computer program products corresponding to the above-summarized methods are also described and claimed herein.

Additional features and advantages are realized through the techniques of exemplary embodiments of the present invention. Other embodiments and aspects of the invention are described in detail herein and are considered a part of the claimed invention. For a better understanding of the invention with advantages and features thereof, refer to the description and to the drawings.

### BRIEF DESCRIPTION OF THE SEVERAL VIEWS OF DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a schematic representation of a cluster tool having multiple processing chambers including a system for processing lots in accordance with an exemplary embodiment of the invention;

FIG. 2 is a flow diagram illustrating a method of processing a lot through a cluster tool having multiple processing chambers in accordance with an exemplary embodiment of the invention; and

FIG. 3 is a schematic block diagram of a general-purpose computer suitable for practicing the present invention exemplary embodiments.

The detailed description explains the exemplary embodiments of the invention, together with advantages and features, by way of example with reference to the drawings.

### DETAILED DESCRIPTION

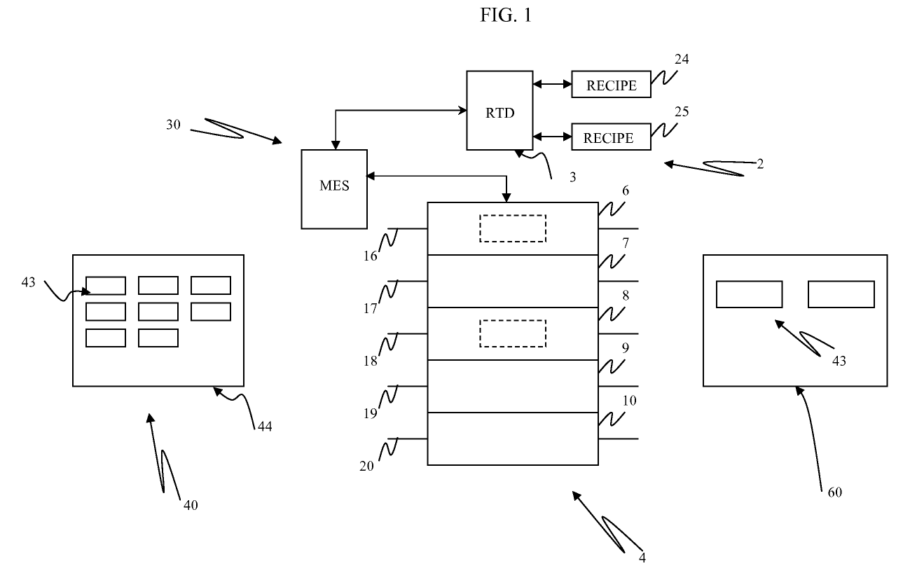

With initial reference to FIG. 1, a system for processing lots on a cluster tool is indicated generally at 2. System 2 includes a real time dispatching (RTD) system 3 operatably coupled to a cluster tool 4 having a plurality of processing chambers 6-10. Each processing chamber 6-10 includes a corresponding flowpath 16-20. RTD 3 employs logical recipes such as indicated at 24 and 25 and communicates with a manufacturing execution system (MES) 30 to deliver a lot to cluster tool 4. More specifically, MES 30 receives tool availability information through tool communication software (not shown). MES 30 then solicits lot availability information from RTD 3. RTD 3 recommends a pending lot having priority for release to production. That is, as will be discussed more fully below, a lot such as indicated at 40, includes a plurality of units to be processed, one of which is indicated at 43, arranged on a transport module 44. Prior to processing, MES 30 determines which processing chambers 6-10 are active, i.e., ready and set up to process lot 40. MES 30 then communicates with RTD 3 and receives a lot recommendation to deliver, for example, each unit 43 of lot 40 to an appropriate one(s) of the processing chambers. Once processed, each unit 43 is placed on an output transport module 60 for further processing or end delivery.

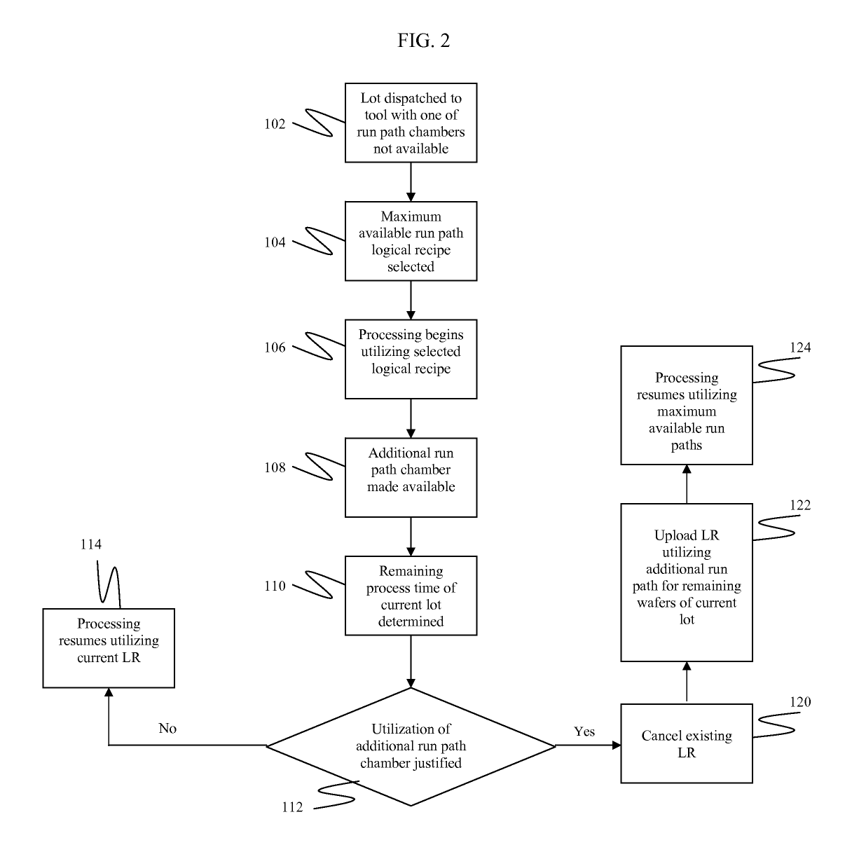

Reference will now be made to FIG. 2 in describing a method 100 of processing lots through a cluster tool having multiple processing chambers in accordance with the present invention. As discussed above, MES 30 determines tool availability information for each tool, and communicates the tool availability information to RTD 3 which then recommends which lot, for example lot 40, to dispatch to cluster tool 4. More specifically, MES 30 determines which of chambers 6-10 are active chambers i.e., chambers available for processing, and inactive chambers i.e., chambers unavailable for processing either for planned or unplanned outages as indicated in Block 102. At this point, RTD 3 recommends a lot for dispatch and sets a logical recipe such as, recipe 24, that utilizes a maximum available runpath for cluster tool 4 as indicated in block 104. That is, RTD 3 selects a recipe that enables as many chambers as possible to be used for processing units 43 allowing, for example, multiple semiconductor wafers to process simultaneously to increase an overall throughput of cluster tool 4. Once the logical recipe is established, cluster tool 4 begins processing lot 40 through the available processing chambers as indicated in block 106.

While processing lot 40, RTD 3 is notified that one of chambers 6-10 previously indicated as being unavailable is now available for processing as indicated in block 108. At this point, RTD 3 determines a processing time required to complete processing of lot 40 as indicated in block 110. If the processing time required to complete processing of the remaining portion of lot 40 is above a predetermined threshold, i.e., if the time required to finish processing lot 40 is less than the time required to switch over or transition to using a greater number of processing chambers, a determination is made in block 112 to continue processing with the existing recipe as indicated in block 114. If however, in block 112, it is determined that the remaining processing time is greater that the time required to switch to a new recipe, the existing logical recipe is canceled as indicated in block 120. At this point, RTD 3 selects a new logical recipe for processing the remaining portion of lot 40 within cluster tool 4. Once the new recipe is loaded, processing resumes utilizing the maximum available runpaths now available, taking into account available and re-activated chambers as indicated in block 124. It should be appreciated that the present invention enables manufacturers to make more productive use out of cluster tools having multiple processing chambers. That is, instead of waiting for a lot to complete processing on a cluster tool having one or more unavailable chambers, the present invention enables real time or on the fly recipe changes to make more efficient use of newly activated chambers to increase throughput of the cluster tools.

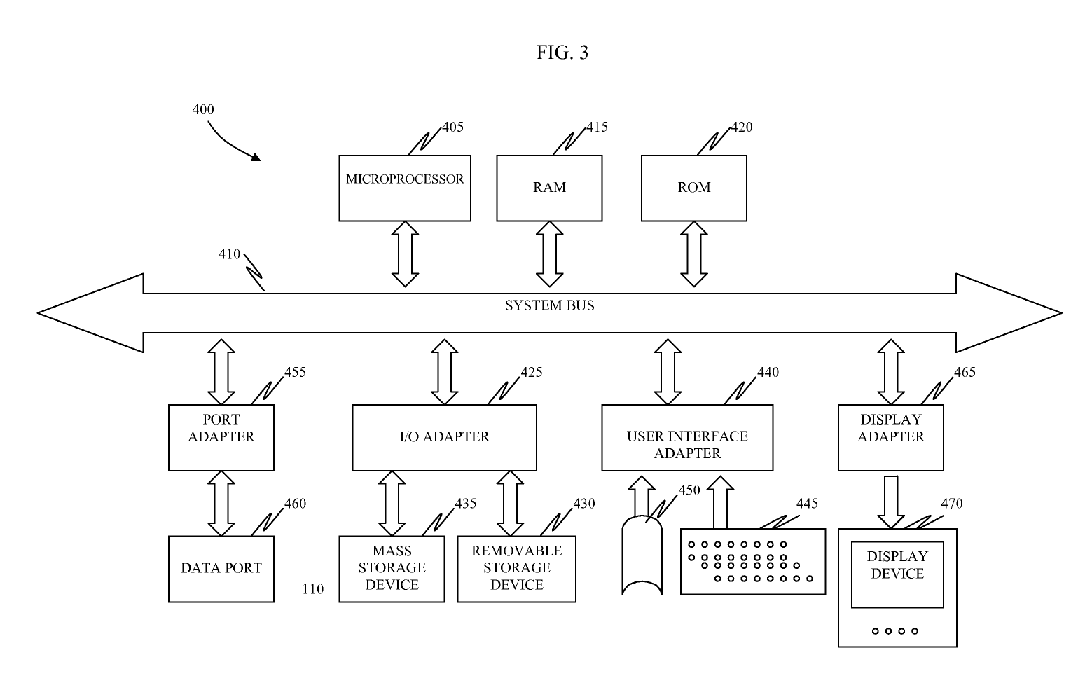

The capabilities of the present invention can be implemented in software, firmware, hardware or some combination thereof. As one example, the method of processing a lot through a cluster tool having multiple processing chambers described herein is practiced with a general-purpose computer and the method may be coded as a set of instructions on removable or hard media for use by the general-purpose computer. FIG. 3 is a schematic block diagram of a general-purpose computer suitable for practicing the present invention embodiments. In FIG. 3, computer system 400 has at least one microprocessor or central processing unit (CPU) 405. CPU 405 is interconnected via a system bus 410 to a random access memory (RAM) 415, a read-only memory (ROM) 420, an input/output (I/O) adapter 425 for a connecting a removable data and/or program storage device 430 and a mass data and/or program storage device 435, a user interface adapter 440 for connecting a keyboard 445 and a mouse 450, a port adapter 455 for connecting a data port 460 and a display adapter 465 for connecting a display device 470.

ROM 420 contains the basic operating system for computer system 400. The operating system may alternatively reside in RAM 415 or elsewhere as is known in the art. Examples of removable data and/or program storage device 430 include magnetic media such as floppy drives and tape drives and optical media such as CD ROM drives. Examples of mass data and/or program storage device 435 include hard disk drives and non-volatile memory such as flash memory. In addition to keyboard 445 and mouse 450, other user input devices such as trackballs, writing tablets, pressure pads, microphones, light pens and position-sensing screen displays may be connected to user interface 440. Examples of display devices include cathode-ray tubes (CRT) and liquid crystal displays (LCD).

A computer program with an appropriate application interface may be created by one of skill in the art and stored on the system or a data and/or program storage device to simplify the practicing of this invention. In operation, information for or the computer program created to run the present invention is loaded on the appropriate removable data and/or program storage device 430, fed through data port 460 or typed in using keyboard 445.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A method of processing a lot through a cluster tool having multiple processing chambers, the method comprising:
dispatching a lot to a cluster tool having a plurality of processing chambers;
determining which of the plurality of processing chambers are active processing chambers and inactive processing chambers;
setting a recipe for processing the lot utilizing the active processing chambers of the cluster tool;
processing a portion of the lot through the active processing chambers;
detecting that at least one of the inactive processing chambers is a re-activated processing chamber;
selectively setting a new recipe for processing a remaining portion of the lot utilizing the active processing chambers and the re-activated processing chamber; and
processing the remaining portion of the lot through the cluster tool based on the new recipe.

2. The method of claim 1, further comprising:
calculating a processing time for processing the remaining portion of the lot based on the new recipe; and
processing the remaining portion of the lot based on the recipe if the processing time for processing the remaining portion of the lot based on the new recipe is below a predetermined threshold.

3. The method of claim 1, wherein setting the recipe for processing the lot utilizing the active processing chambers includes establishing a recipe that utilizes a maximum available run path for the cluster tool.

4. A system for processing a lot through a cluster tool having multiple processing chambers comprising:
a cluster tool having multiple processing chambers;
a real time dispatching system including a central processing unit (CPU), said CPU being interconnected functionally via a system bus to:
an input/output (I/O) adapter connecting to at least one of a removable data storage device, a program storage device, and a mass data storage device;
a user interface adapter connecting to a keyboard and a mouse;
a display adapter connecting to a display device; and
at least one memory device thereupon stored a set of instructions which, when executed by said CPU, causes said system to:
dispatch a lot to a cluster tool having a plurality of processing chambers;
determine which of the plurality of processing chambers are active processing chambers and inactive processing chambers;
set a recipe for processing the lot utilizing the active processing chambers of the cluster tool;
process a portion of the lot through the active processing chambers;
detect that at least one of the inactive processing chambers is a re-activated processing chamber;
selectively set a new recipe for processing a remaining portion of the lot utilizing the active processing chambers and the reactivated processing chamber; and
process the remaining portion of the lot through the cluster tool based on the new recipe.

5. The system of claim 4, wherein, the set of instructions which, when executed by said CPU, causes said system to:
calculate a processing time for processing the remaining portion of the lot based on the new recipe; and
process the remaining portion of the lot based on the recipe if the processing time for processing the remaining portion of the lot based on the new recipe is below a predetermined threshold.

6. The system of claim 4, wherein, the set of instructions which, when executed by said CPU, causes said system to: set the recipe for processing the lot utilizing the active processing chambers by establishing a recipe that utilizes a maximum available run path for the cluster tool.

7. A computer program product comprising:
a computer useable medium including a computer readable program, wherein the computer readable program when executed on a computer causes the computer to:
dispatch a lot to a cluster tool having a plurality of processing chambers;
determine which of the plurality of processing chambers are active processing chambers and inactive processing chambers;
set a recipe for processing the lot utilizing the active processing chambers of the cluster tool;
process a portion of the lot through the active processing chambers;
detect that at least one of the inactive processing chambers is a re-activated processing chamber;
selectively set a new recipe for processing a remaining portion of the lot utilizing the active processing chambers and the reactivated processing chamber; and
process the remaining portion of the lot through the cluster tool based on the new recipe.

8. The computer program product of claim 7, wherein the computer readable program when executed on a computer causes the computer to:
calculate a processing time for processing the remaining portion of the lot based on the new recipe; and
process the remaining portion of the lot based on the recipe if the processing time for processing the remaining portion of the lot based on the new recipe is below a predetermined threshold.

9. The computer program product of claim 7, wherein the computer readable program when executed on a computer causes the computer to: set the recipe for processing the lot utilizing the active processing chambers by establishing a recipe that utilizes a maximum available run path for the cluster tool.
